(19) United States
(12) Patent Application Publication
(10) Pub. No.: US 2008/0256862 A1
(43) Pub. Date: Oct. 23, 2008

(54) Device for Opening and/or Closing a Door

(75) Inventors: Holger Hansch, Witten (DE); Michael Glanz, Koln (DE); Michael Hufen, Wuppertal (DE); Bemd Brieseck, Plettenberg (DE)

Correspondence Address: COHEN, PONTANI, LIEBERMAN & PAVANE LLP, 551 FIFTH AVENUE, SUITE 1210, NEW YORK, NY, 10176, US

(73) Assignee: Dorma GmbH + Co. KG, Ennepetal (DE)

(21) Appl. No.: 11/795,057

(22) PCT Filed: Dec. 8, 2005
(86) PCT No.: PCT/EP2005/013151

§ 371 Date: Apr. 14, 2008

(30) Foreign Application Priority Data
Jan. 11, 2005 (DE) 10 2005 001 314.7

(51) Int. Cl. E05F 15/10

(52) U.S. Cl. 49/32

(57) ABSTRACT

The invention relates to a device for opening and/or closing a door comprising an electric motor and other electrical, mechanical, and/or hydraulic driving elements as well as a support (50) for accommodating the driving elements. The aim of the invention is to create a device for opening and/or closing a door in which the entire drive unit can be assembled using a few manipulations such that the drive can be serially produced with little effort. Said aim is achieved by plugging a preassembled motor-gear unit (20), a conductor card (30), and a harness with a transformer (40) into the support (50) and electrically interconnecting the same by means of a connecting plug (45).

### CROSS-REFERENCE TO RELATED APPLICATIONS

This is a U.S. national stage of International Application No. PCT/EP2005/013151, filed on 8 Dec. 2005. Priority is claimed on German Application No. 10 2005 001 314.7, filed on 11 Jan. 2005.

The invention relates to a device for opening and/or closing a door with an electrical motor and with further electrical, mechanical and/or hydraulic driving elements and with a support for receiving the driving elements.

A so-called servo-closer with a hydraulic piston/cylinder unit, with a closing spring and opening motor, consisting of an electrical motor and a hydraulic pump, is described in DE 43 23 150 A1. The electrical motor and the pump, as a structural unit, are integral with a superior housing. The housing consists of a base plate, which is screwed onto the door leaf or the door frame, two lateral parts and a frontal cover hood. The electrical motor with the pump are laterally flange-mounted to the housing.

This state-of-the-art is disadvantageous in that the motor for each individual servo-closer needs to be individually flange-mounted to the pump and to the housing. With a production of several thousands of servo-closers per year, the series fabrication is very expensive.

The object of the invention is to provide a device for opening and/or closing a door, in which the complete drive can be mounted with a few manipulations such that the series fabrication can be realized at lower expense.

The invention solves the given problem with the teaching according to claim 1.

In order to rationalize the series fabrication, a pre-mounted motor-gear-unit, a printed circuit board and a cable harness with transformer are inserted into the support and are electrically interconnected by means of connectors. The motor-gear-unit, the printed circuit board and the cable harness with transformer are delivered by the suppliers completely pre-mounted and tested, and can be mounted into the support with a few manipulations.

For receiving the pre-mounted components, the support has at least one aperture for receiving the motor-gear-unit and at least one aperture for receiving the printed circuit board and the cable harness with the transformer. Furthermore, the support is provided with an aperture for a connector module.

The motor-gear-unit is entirely pre-mounted on a base plate. However, the base plate may be also integral part of the housing of the motor-gear-unit, or may be integrally connected to the latter.

The base plate is provided with bores or oblong holes for the attachment to a mounting plate. Vibration dampers can be mounted into the bores or the oblong holes.

The printed circuit board consists of a first and second control board, which are disposed at an angle to each other and are interconnected by means of cable links.

The cable harness with transformer consists of a transformer, a power cable, a power plug and at least one connecting plug. In a preferred embodiment, the support has a cable conduit, in which the power cable is run. This results in a traction relief for the plugs and connections disposed within the support.

The electrical connection of the cable harness with transformer and the printed circuit board is realized via insulated connecting plugs. Covering the printed circuit board and the transformer with a covering achieves an electrically screened functional unit, which makes screwing of the covering unnecessary.

The mounted support is attached to a mounting plate, which has two pairs of threaded bushings, wherein each pair of the threaded bushings corresponds to the bores or oblong holes in the base plate. Thereby, once the mounting plate is attached, the support or the entire door operator are optionally rotatable about 180° and are thus usable for DIN-left or DIN-right applications.

Screw channels, which correspond to the bores or oblong holes in the base plate and to the threaded bushings of the mounting plate, are machined into the support. By screwing the support to the mounting plate, the base plate of the motor-gear-unit is likewise fixed, in this case, the motor-gear-unit being attached to the support by clamping members and latching projections.

In an alternative embodiment, the screw channels are through bores. As the motor-gear-unit is connected to the support via latching projections and clamping members, it is sufficient to connect the base plate of the motor-drive unit to the mounting plate via screws. In this case, the screw channels allow for access to the screws, which are secured against the risk of being lost and engage into the mounting plate through the base plate.

In the following, the invention will be explained in more detail, reference being made to an exemplary embodiment, in which:

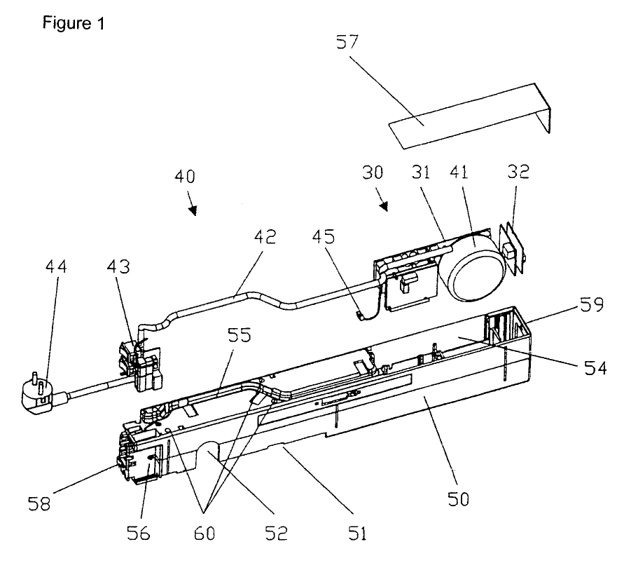

FIG. 1 shows, in a perspective view, a support with printed circuit board and a cable harness with transformer;

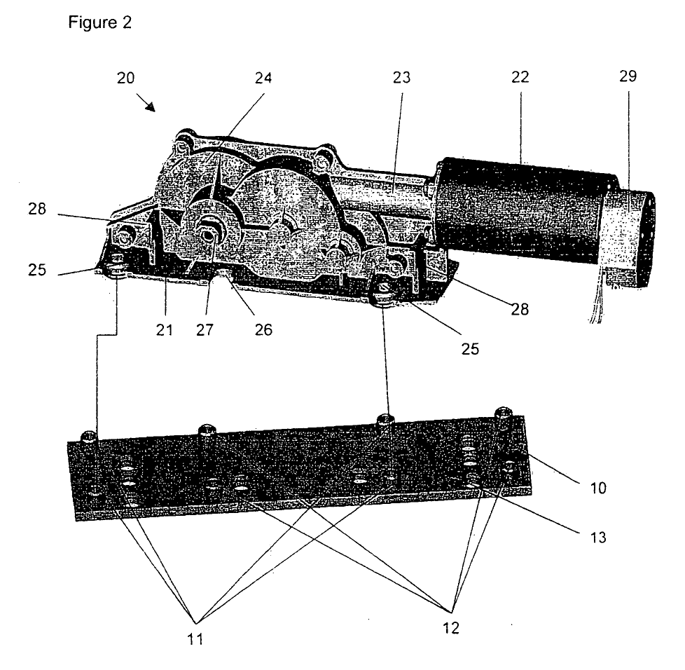

FIG. 2 shows a view on the motor-gear-unit and the mounting plate; and

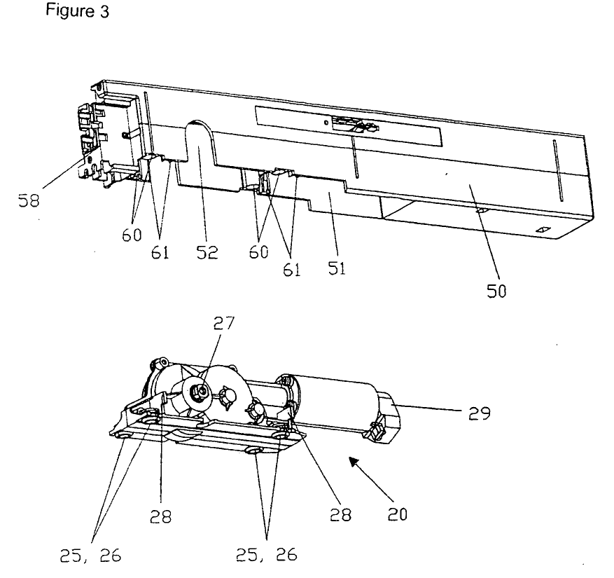

FIG. 3 shows a view on the support with the motor-gear-unit.

FIG. 1 shows an elongate support 50 having a substantially rectangular cross-section. On the rear side when mounted, namely in the direction of the door or the wall, the support 50 has an aperture 51 for a motor-gear-unit, not illustrated in this Figure, as well as a shaft opening 52. On the front side when mounted, namely in the direction of the user, an aperture 54 is also provided for a cable harness with transformer 40 and for a printed circuit board 30. The apertures 51 and 54 are disposed at opposite ends of the support 50. A cable conduit 55 is recessed, likewise on the front side of the support 50. An aperture 56 for connectors is provided at a first frontal face 58 of the support 50. Several screw channels 60 are disposed at the support 50, which pass through the inside of the support 50. Not illustrated screws, protected against the risk of being lost, are inserted into these screw channels 60. Each aperture 51 and 54 at the front or at the rear side of the support 50 is associated to one frontal face 58 or 59 respectively such that the result is a torsion-resistant support 50, which can be manufactured from sheet metal, light metal or plastic material.

A printed circuit board 30 is executed as a so-called “broken and folded” printed circuit board consisting of a first control plate 31 and a second control plate 32. The second control plate 32 may as well consist of several superposed control plates. Both control plates 31, 32 could be disposed in plane on one plate. However, due to space conditions and the function, they are disposed at an angle to each other. Therefore, the second control plate 32 can serve simultaneously as a support for not illustrated indicating devices or switches, which are integral with the second frontal face 59 of the support 50. The control plates 31 and 32 are interconnected via not illustrated cable links.

A pre-fabricated cable harness with transformer 40 substantially consists of a transformer 41, a power cable 42, a power plug 44 and of at least one connecting plug 45. As an alternative, the cable harness with transformer may have also directly an integral connector module 43, which is disposed at or between the power cable 42 and the power plug 44.

FIG. 2 illustrates a motor-gear-unit 20, which consists of a base plate 21 and a motor 22 disposed on the base plate 21, a drive shaft 23 and a gear 24. A not illustrated motor control with connector 29 is attached at the motor 22. However, the base plate 21 may be integral part of the housing of the motor-gear-unit 20, or may be integrally connected to the latter. Bores or oblong holes 26, which are able to accommodate the vibration dampers 25, are machined into the base plate 21. The vibration dampers 25 can be made from rubber, plastic material or from any other elastic material. Latching projections 28 are attached to the base plate 21 and/or to the gear 24. In this example, the motor-gear-unit 20 is an electro-mechanical drive unit. Obviously, as an alternative, other drive units, such as hydraulic-mechanical or similar drive units are also possible. It is essential in this case only that the entire drive unit, as an independent component or as a module, is completely pre-mounted installed in the support 50.

A mounting plate 10 has several bores 13, by means of which an attachment of the entire door operator to a wall, a door, a door frame or to another mounting plate, can be realized via screws or the like. In this example, four threaded bushings 11 and 12 respectively are provided on the mounting plate 10 which correspond to the oblong holes 26 of the base plate 21. The mounting plate 10 with the bores 13 and the threaded bushings 11 and 12 is formed symmetrically to allow for change-over. Depending on the opening direction (DIN left or DIN right) of the door, the entire door operator, with the mounting plate 10 already attached, can be rotated about 180°, by placing the oblong holes 26 of the base plate 21, in this case, not onto the threaded bushings 11, but, after a rotation of the door operator, onto the threaded bushings 12.

The first step in the mounting process of the door operator according to FIG. 1 is as follows: The printed circuit board 30, including the first and the second control plate 31, 32, is inserted into the aperture 54 of the support 50 in not illustrated reception slots. The transformer 41 is likewise recessed in a not illustrated reception slot. The transformer 41 and the printed circuit board 30 are interconnected by means of one or more connecting plugs 45. The connector module 43 is inserted into the aperture provided for the connector 56 and fixed via a clip-connection. The power cable 42 of the transformer 41 is run in the cable conduit 55. In this way the integral connectors and the connections are traction relieved, if a too important load is applied to the power cable 42 or the power plug 44. The aperture 54 is then closed with a covering 57, which is likewise fixed by a clip-connection. Thus an electrically screened functional unit is achieved, which does not require subsequent screwing of a cover hood. The execution of a covering or casing which is releasable only by tools is likewise unnecessary.

In the second mounting step according to FIG. 3, the motor-gear-unit is inserted into the aperture 51. At the same time the cabling of the motor-gear-unit 20 via the motor control with connector 29 with the transformer 41 and the printed circuit board 30 via the connecting plug 45 (see FIG. 1) is realized. The drive shaft 27 of the motor-gear-unit 20 engages with the shaft opening 52. The latching projections 28 engage into the clamping members 61 and are arrested therein. The motor-gear-unit 20 is thus fixed in the support 50. The oblong holes 26 with the vibration dampers 25 are in true alignment with the screw channels 60.

Also the cabling of the motor-gear-unit 20 by means of insulated connectors with the one or more connecting plugs 45 of the cable harness with transformer 40 contributes to achieve an electrically screened functional unit.

the door or the door frame by means screws or the like via the bores 13. The completely equipped support 50, including its vibration dampers 25, is then placed onto the threaded bushings 11. This allows for an easy preliminary fixing. Subsequently, the screws disposed in the screw channels 60 pass through the vibration dampers 25 and are screwed to the threaded bushings 11.

In an alternative embodiment, the screw channels 60 are through bores. As the motor-gear-unit 20 is connected to the support 50 via latching projections 28 and clamping members 61, it is sufficient to connect the base plate 21 of the motor-drive unit 20 to the mounting plate 10 via screws. In this case, the screw channels 60 enable the access to the screws, which are secured against the risk of being lost and engage into the mounting plate 10, through the base plate 21. As the aperture 51 for the motor-gear-unit 20 extends only over a partial length of the support 50, also the mounting plate 10 is significantly shorter than the support 50.

A not illustrated cover hood with end caps is then placed onto the support 50 and attached by means of a clip-connection.

### LIST OF REFERENCE NUMERALS

10 mounting plate
11 threaded bushing
12 threaded bushing
13 bore
20 motor-gear-unit
21 base plate
22 motor
23 drive shaft
24 gear
25 vibration damper
26 oblong hole
27 drive shaft
28 latching projection
29 motor control with connector
30 printed circuit board
31 first control plate
32 second control plate
40 cable harness with transformer
41 transformer
42 power cable
43 connector module
44 power plug
45 connecting plug
50 support
51 aperture (for motor-gear-unit)
52 shaft opening
54 aperture (for printed circuit board and transformer)
55 cable conduit
56 aperture (for plug)
57 covering
58 first frontal face
59 second frontal face
60 screw channel
61 clamping member

What is claimed is:

1.-15. (canceled)

16. A device for opening/closing a door, comprising:
a support;
a pre-mounted motor-gear-unit inserted in the support;
a printed circuit board inserted in the support; and
a cable harness inserted in the support and comprising a transformer and connecting plugs,
wherein the motor-gear-unit, the printed circuit board and the transformer are electrically interconnected by the connecting plugs.

17. The device of claim 16, wherein the support has a first aperture for receiving the motor-gear-unit, and a second aperture for receiving the printed circuit board and the cable harness.

18. The device of claim 16, wherein the support has a cable conduit.

19. The device of claim 16, wherein the cable harness further comprises a connection module and the support has an aperture for receiving the connector module.

20. The device of claim 16, wherein the support has screw channels.

21. The device of claim 20, wherein the entire motor-gear-unit is pre-mounted on a base plate.

22. The device of claim 21, further comprising a mounting plate connectable to the support, the base plate having oblong holes for attachment to the mounting plate.

23. The device of claim 22, further comprising vibration dampers which are respectively received in the oblong holes.

24. The device of claim 16, wherein the printed circuit board comprises a first control board and a second control board which are disposed at an angle to each other in the support and are electrically interconnected.

25. The device of claim 18, wherein the cable harness further comprises a power cable and a power plug electrically connected to the power cable.

26. The device of claim 25, wherein the power cable is received in the cable conduit.

27. The device of claim 16, further comprising a covering which covers the transformer and the printed circuit board.

28. The device of claim 22, wherein the mounting plate has two pairs of first threaded bushings and two pairs of second threaded bushings, the first or second threaded bushings corresponding to the oblong holes of the base plate.

29. The device of claim 28, further comprising screws, each screw extending through a respective screw channel of the support and a respective oblong hole of the base plate and being threaded into a respective threaded bushing of the mounting plate to connect the support and the base plate to the mounting plate, whereby the mounting plate and the motor-gear-unit simultaneously connected to the support by the screws.

30. The device of claim 28, further comprising screws, each screw extending through a respective screw channel of the support and a respective oblong hole of the base plate so that the support is connected to the motor-gear-unit and the base plate is connected to the mounting plate.
